(19) United States
(12) Patent Application Publication
(10) Pub. No.: US 2007/0269188 A1
(43) Pub. Date: Nov. 22, 2007

(54) Image correction method for drive recorder, drive recorder, and drive recorder system

(75) Inventor: Takashi Shiga, Gunma-ken (JP)

Correspondence Address: NATH & ASSOCIATES, PLLC, Sixth Floor, 1030 15th Street, N.W., Washington, DC, 20005, US

(73) Assignee: VICTOR COMPANY OF JAPAN, LIMITED, Yokohama (JP)

(21) Appl. No.: 11/798,544

(22) Filed: May 15, 2007

(30) Foreign Application Priority Data
May 16, 2006 (JP) P2006-136658

(51) Int. Cl. H04N 5/91; H04N 7/00

(52) U.S. Cl. 386/107

(57) ABSTRACT

A drive recorder has: a camera; an image recording section that records an image captured by the camera; a sensor that is installed with its relative posture with respect to the camera being fixed, detects an acceleration, and outputs an acceleration signal; and an image correcting section that corrects a top-and-bottom direction or an inclination of an image that is recorded in the image recording section.

### BACKGROUND OF THE INVENTION

1. Field of the Invention

The present invention relates to an image correction method for a driver recorder that records images of local circumstances of a vehicle before and after occurrence of a vehicle accident to further clarify a situation at the time of occurrence of the accidence, and to a drive recorder and a drive recorder system, and more particularly to an image correction method for a drive recorder that automatically corrects a top-and-bottom direction of a captured image obtained from a camera of the drive recorder, and to a drive recorder and a drive recorder system.

2. Description of the Related Art

A drive recorder is a device that is installed in a vehicle, e.g., an automobile and records a situation at the time of occurrence of an accident to further clarify a cause of occurrence of the accident, and it is widely spread in not only a business automobile, e.g., a taxi but also a private car. As types of the drive recorder, there are one that records a signal indicative of a vehicle traveling state, e.g., a vehicle speed, an acceleration, a braking pressure, or a handle steering angle before and after occurrence of an accident, one that includes a camera that images local circumstances of a vehicle and has an image recording function of capturing and recording images (including a moving image and a still image hereinafter) of local circumstances of the vehicle before and after occurrence of an accident, and others. Among others, the drive recorder having the image recording function is becoming a mainstream of the drive recorder since it can be readily installed in a vehicle and allows a driver to confirm a situation at the time of occurrence of an accident as an image directly through his/her eyes, thus facilitating comprehension of the situation at the time of occurrence of the accident.

The drive recorder having the image recording function has a camera that shoots local circumstances, an image recording section that records the captured image obtained by the camera, and a shock sensor that senses an impact at the time of an accident as main constituent elements. In general, such a drive recorder continuously records captured images from the camera that constantly shoots local circumstances in such a manner that images are sequentially updated from the order ones. When the shock sensor senses an impact at the time of accident, the drive recorder saves recorded images in a fixed time before and after the accident.

The drive recorder having the image recording function can be roughly classified into two types. One is a drive recorder having a camera mounted on a drive recorder main body itself. The other one is a driver recorder that has a camera connected with a drive recorder main body through, e.g., a cable and is installed at a different position in a vehicle. In any case, as an installation state when installing a camera of the drive recorder having the image recording function in a vehicle, taking one of the following two conformations can be considered. That is, a camera 12 is mounted on, e.g., a dashboard of a vehicle 60 as represented by an installation state A depicted in FIG. 1, or the camera 12 is hung from an interior roof of the vehicle 60 as represented by an installation state B. However, the camera 12 may include attaching means, e.g., a fixing screw on one of a top surface and bottom surface alone. When such a camera is used, a vertical direction of the camera 12 may be reversed depending on the installation state A and the installation state B. Therefore, when the image recording section records a captured image from the camera 12 as it is, this image may be recorded as an image whose top-and-bottom direction is reversed in some cases. Accordingly, when installing the camera 12 of the drive recorder, the vertical direction of the camera 12 must be carefully confirmed to avoid reversal of the top-and-bottom direction of a recorded image.

Further, in order to reproduce a recorded image recorded and saved by an image recording section in a conventional drive recorder, a reproduction device, e.g., a personal computer must reproduce the recorded image after, e.g., taking out a recorded image file. Therefore, confirming whether a top-and-bottom direction of the recorded image is correct in advance takes time and labor.

In regard to this point, according to the invention concerning a safety drive recorder disclosed in Jpn. Pat. Appln. KOKAI Publication No. H11(1999)-142181, as shown in FIG. 2, since a captured image and a recorded image from a camera 12 installed in a vehicle can be confirmed in a screen 2, a top-and-bottom direction of the recorded image can be confirmed at the time of installation.

However, in the invention disclosed in Jpn. Pat. Appln. KOKAI Publication No. H11(1999)-142181, a person must confirm a vertical direction of the camera when installing the camera in the vehicle, and the camera must be installed by using a method in accordance with an installation state. Therefore, this invention has a problem that a camera installing operation is troublesome. Further, adding a function of automatically correcting a top-and-bottom direction of an image captured by camera can be considered, but special means for detecting a vertical direction of the camera is required. Therefore, the technique has a problem of an increase in cost of components required for this means.

### SUMMARY OF THE INVENTION

In view of the above-explained problems, it is an object of the present invention to provide an image correction method for a drive recorder that automatically corrects a top-and-bottom direction of an image captured by a camera, can be readily installed in a vehicle, and suppresses an increase in cost without adding components that detect a vertical direction of the camera, and also provide a drive recorder and a drive recorder system.

To achieve this object, there is provided a recorded image correction method for a drive recorder, comprising: generating an acceleration signal from a sensor that detects an acceleration; and correcting a top-and-bottom direction or an inclination of a captured image that is output from a camera (12) and recorded in a drive recorder based on the acceleration signal.

Further, to achieve the object, there is provided a drive recorder (50) comprising: a camera (12); an image recording section (16) that records an image captured by the camera; a sensor (14) that is installed with its relative posture with respect to the camera being fixed, detects an acceleration, and outputs an acceleration signal; and an image correcting section (17) that corrects a top-and-bottom direction or an inclination of an image that is recorded in the image recording section based on the acceleration signal.

A preferred embodiment of the present invention further comprises an image display section (42) that displays the image output from the camera (12) or the image recorded in the image recording section (16).

Furthermore, to achieve the object, there is provided a drive recorder system (50b) comprising: a camera (12); an image recording section (16) that is different from the camera, receives an image captured by the camera with or without a wire; a sensor (14) that is installed with its relative posture with respect to the camera being fixed, detects an acceleration, and outputs an acceleration signal; and an image correcting section (17) that corrects a top-and-bottom direction or an inclination of an image recorded in the image recording section based on the acceleration signal.

A preferred embodiment according to the present invention further comprises an image display section (42) that displays the image output from the camera (12) or the image recorded in the image recording section (16).

The image correction method for a drive recorder, the drive recorder, and the drive recorder system according to the present invention have the above-explained structure, and hence the following functions can be realized.

(1) Since a top-and-bottom direction of an image captured by the camera of the drive recorder and the drive recorder system is automatically corrected, installation can be facilitated without being concerned about a vertical direction of the camera.

(2) Since an acceleration sensor of the driver recorder and the driver recorder system is used as means for judging a vertical direction of the camera of the drive recorder and the drive recorder system, an increase in component cost can be suppressed without newly requiring components.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a schematic view showing an installation state when installing a camera of a drive recorder in a vehicle;

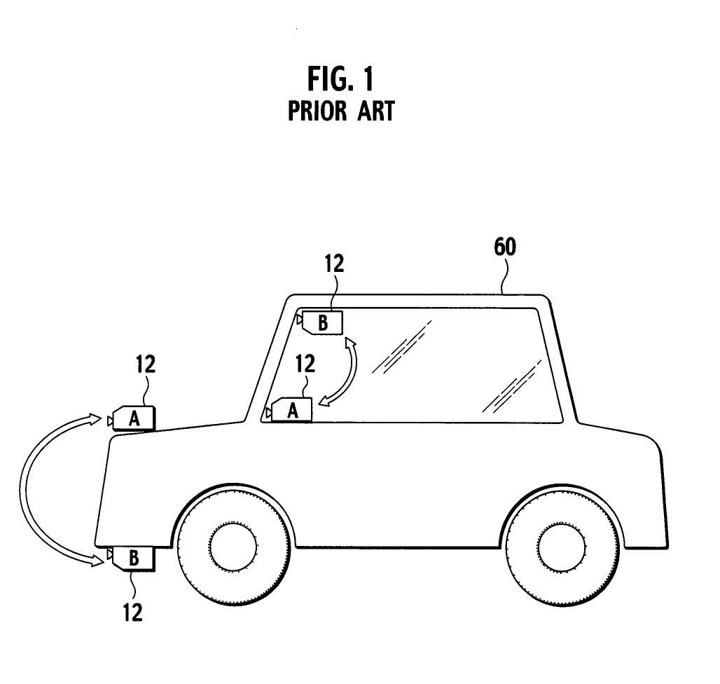

FIG. 2 is an appearance diagram of a conventional drive recorder;

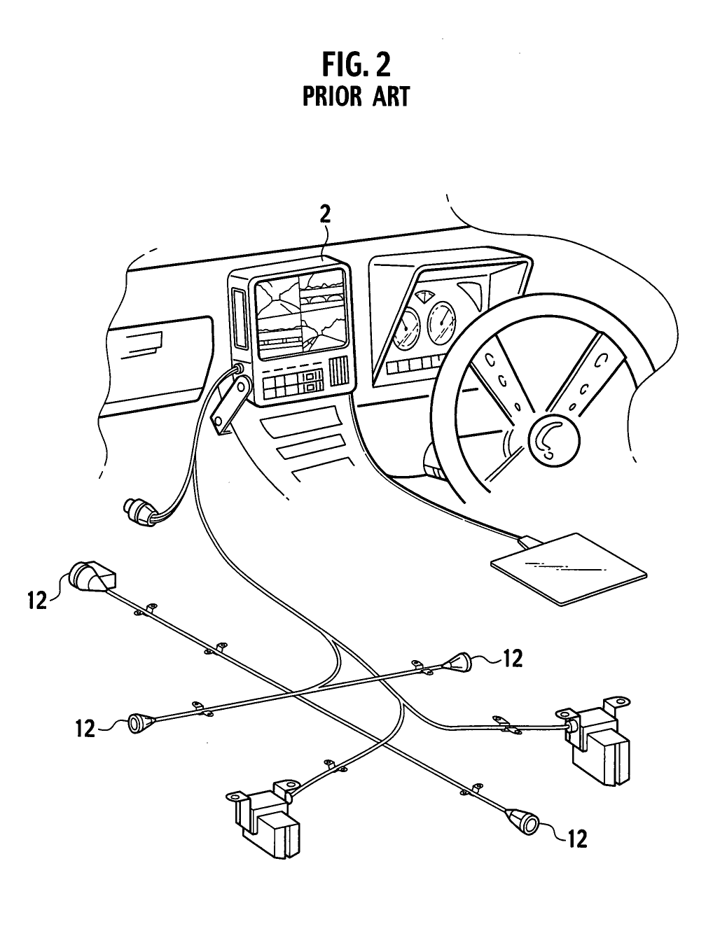

FIG. 3 is a block diagram of a drive recorder according to an embodiment of the present invention;

FIGS. 4A to 4C are views for explaining an image correction method for a drive recorder according to the embodiment of the present invention;

FIG. 5 is a block diagram of a drive recorder having an image display section according to the embodiment of the present invention; and

FIGS. 6A and 6B are block diagrams of an example where a camera section and a main body are separately provided in a drive recorder system according to the embodiment of the present invention.

### DETAILED DESCRIPTION OF THE PREFERRED EMBODIMENTS

An embodiment of an image correction method for a drive recorder, a drive recorder, and a drive recorder system according to the present invention will now be explained with reference to the accompanying drawings.

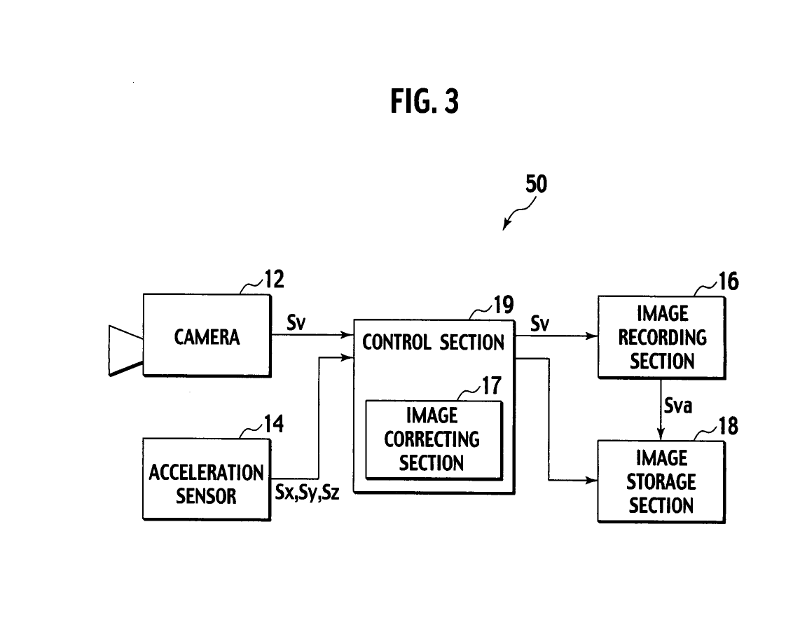

FIG. 3 is a block diagram of a drive recorder according to this embodiment.

In FIG. 3, a drive recorder 50 according to this embodiment includes: a camera 12 that shoots local circumstances of a vehicle; an acceleration sensor 14 as a sensor that detects an acceleration to sense an impact; an image recording section 16 that records an image captured by the camera 12; an image storage section 18 that stores recorded images before and after occurrence of an accident when the accident occurs; and a control section 19 that controls the drive recorder 50 itself and has an image correcting section 17 that corrects the image captured by the camera 12 based on an acceleration signal from the acceleration sensor 14. The acceleration sensor 14 and the camera 12 are installed with their relative posture being fixed in such a manner that a vertical direction of the acceleration sensor 14 is reversed when a vertical direction of the camera 12 is reversed.

The following explanation uses an example where the acceleration sensor 14 and the camera 12 are installed with their relative posture being fixed in such a manner that their vertical directions match with and become parallel with each other. Further, the explanation will be given on the assumption that the image includes both a moving image and a still image.

The camera 12 that shoots local circumstances is installed inside or outside a vehicle to shoot local circumstances of the vehicle. Although the camera 12 shoots a front side and a rear side of the vehicle or a lateral surface direction of the vehicle as local circumstances to be shot, the camera 12 is usually installed to shoot the front side of the vehicle. As a shooting element of the camera 12, a CCD or a CMOS can be used, the CCD is often utilized in particular. Furthermore, as a lens used in this camera 12, adopting a wide-angle lens enabling shooting in a wider range is preferable. Moreover, the plurality of cameras 12 may be provided. In this case, it is assumed that relative postures of the plurality of cameras 12 and the acceleration sensor 14 are all fixed.

The acceleration sensor 14 senses a dynamic acceleration that is produced in a short time or suddenly changes due to, e.g., an impact shock at the time of occurrence of an accident or a static acceleration, e.g., a gravitational force that constantly and fixedly functions, and thereby outputs an acceleration signal in accordance with the acceleration. As the main acceleration sensor 14, there is a piezoresistance type acceleration sensor, a piezoelectric type acceleration sensor, or an electrostatic capacity type acceleration sensor. Among others, adoption of the piezoelectric type three-dimensional acceleration sensor that that is small in size and can sense accelerations in three directions, i.e., directions of an X axis, a Y axis, and a Z axis by using one part is particularly preferable.

As the image recording section 16 that records a captured image obtained by the camera 12 or the image storage section 18 that stores recorded images recorded by the image recording section 16 before and after occurrence of an accident, a semiconductor memory, e.g., a DRAM or an SRAM or a non-volatile memory, e.g., a flash memory is often used. Moreover, a hard disk, a recordable/erasable optical disk, a magneto-optical disk, or a magnetic tape can be used for the image recording section 16 and the image storage section 18. Additionally, the image recording section 16 may be configured to also function as the image storage section 18 without separately providing the image recording section 16 and the image storage section 18.

The control section 19 recognizes occurrence of an accident from an acceleration signal from the acceleration sensor 14, and controls the image recording section 16 and the image storage section 18 to perform predetermined operations. Further, the image correcting section 17 of the control section 19 judges a vertical direction of the camera 12 from a later-explained vertical acceleration signal of the acceleration sensor 14, and corrects a recorded image to prevent a top-and-bottom direction of this image from being reversed as required.

An operation of the drive recorder 50 at the time of occurrence of an accident will now be explained by using an example where the acceleration sensor 14 is a three-dimensional acceleration sensor. It is to be noted that an image correction method for the drive recorder 50 will be explained later and an example where a captured image from the camera 12 is not reversed and the control section 19 does not correct the captured image will be explained.

In FIG. 3, the camera 12 of the drive recorder 50 constantly shoots local circumstances of a vehicle, and outputs an obtained captured image as an image signal Sv to the image recording section 16 through the control section 19. The image recording section 16 continuously records the image signal Sv from the cameral 12 while sequentially updating the oldest information of the already recorded image signals Sv. The acceleration sensor 14 senses an acceleration of the vehicle, and outputs acceleration signals Sx, Sy, and Sz in three directions, i.e., both horizontal directions of an X axis and a Y axis and a vertical direction (a Z axis direction) in accordance with the acceleration. It is to be noted that the acceleration signal Sx corresponds to an acceleration in the X axis direction (e.g., a right-and-left direction of the vehicle); the acceleration signal Sy, an acceleration in the Y axis direction (e.g., a front-and-back direction of the vehicle); and the acceleration signal Sz, the Z axis direction (e.g., a top-and-bottom direction of the vehicle), respectively. When at least one of the acceleration signals Sx, Sy, and Sz from the acceleration sensor 14 exceeds a predetermined value, the control section 19 recognizes occurrence of an accident, allows the image recording section 16 to stop recording the image signal Sv after elapse of a predetermined time, and stores in the image storage section 18 image signals Sva in a predetermined time period before and after the control section 19 recognizes occurrence of the accident. A situation at the time of occurrence of the accident is confirmed by reproducing the image signals Sva before and after occurrence of the accident stored in the image storage section 18.

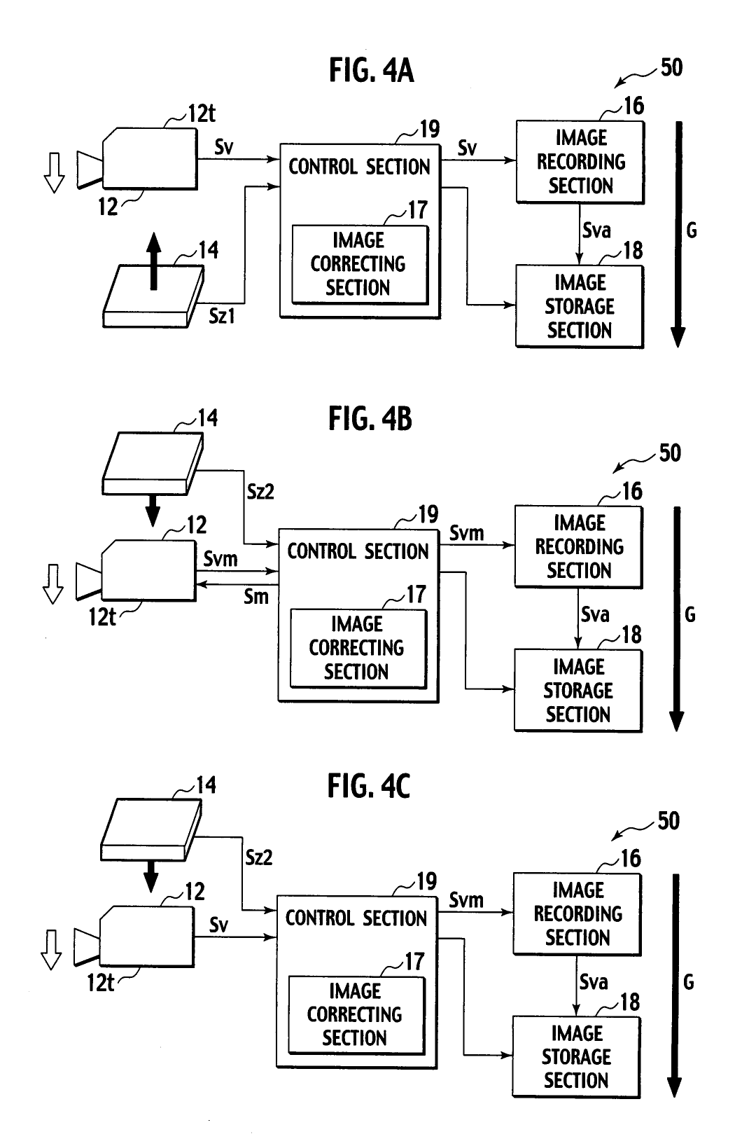

FIGS. 4A to 4C are views for explaining an image correction method for the drive recorder according to the embodiment.

A method of automatically correcting a top-and-bottom direction of an image captured by the camera 12 will now be explained with reference to FIGS. 4A to 4C. It is to be noted that an outline arrow in FIGS. 4A to 4C indicates a vertical direction of the camera; a black arrow, a positive vertical direction of the acceleration sensor 14; and an arrow G, a direction of a gravitational acceleration.

In a state depicted in FIG. 4A where the positive vertical direction of the acceleration sensor 14 is an upward direction and an upper surface 12t of the camera 12 faces upward (is erected), the acceleration sensor 14 receives the gravitational sensor G in a negative vertical direction. As explained above, since the acceleration sensor 14 can also sense a static acceleration like the gravitational acceleration G, the acceleration sensor 14 outputs an acceleration signal Sz1 indicating that the gravitational acceleration G (9.8 m/s²) is applied in the negative vertical direction to the image correcting section 17 of the controller 19. In this case, since the top-and-bottom direction of the image signal Sv output to the image recording section 16 from the camera 12 is not reversed, the image correcting section 17 does not correct the captured image. Therefore, the image recording section 16 records the image signal Sv from the camera 12 as it is.

In a state depicted in FIG. 4B where the camera 12 is disposed with the upper face 12t facing downward (being inverted), a relative posture is fixed in such a manner that the vertical direction of the acceleration sensor 14 and the top-and-bottom direction of the camera 12 become parallel with each other along the same direction. Therefore, when the vertical direction of the camera 12 is reversed, the positive/negative direction of the acceleration sensor 14 is also reversed. Accordingly, the positive vertical direction of the acceleration sensor 14 is the downward direction, and the acceleration sensor 14 receives the gravitational acceleration G in the positive vertical direction. Therefore, the acceleration sensor 14 outputs an acceleration signal Sz2 indicating that the gravitational acceleration G is applied in the positive vertical direction to the image correcting section 17 of the control section 19.

A discriminable difference is produced between the acceleration signal Sz1 when the gravitation acceleration G is applied in the negative vertical direction and the acceleration signal Sz2 when the gravitational acceleration G is applied in the positive vertical direction, and hence the image correcting section 17 of the control section 19 can determine the vertical direction of the disposed camera 12 based on the acceleration signals Sz.

In the example depicted in FIG. 4B, when the image recording section 16 records the image signal Sv from the camera 12 as it is, the top-and-bottom direction of the recorded image is reversed. Therefore, when the image correcting section 17 receives the acceleration signal Sz2 from the acceleration sensor 14, it transmits to the camera 12 a mirroring signal Sm that activates a mirroring function that turns the captured image upside down. The mirroring function is a function that is generally provided in an image processing LSI of the camera 12 and mirror-reverses an output order of the image signals Sv to be output. In this embodiment, a vertical flipping function is also included in the mirroring function. Upon receiving the mirroring signal Sm from the image correcting section 17, the camera 12 activates the vertical mirroring function to output an image signal Svm obtained by vertically reversing the output order of the image signal Sv. The image recording section 16 records this image signal Svm. As a result, the image recorded by the image recording section 16 is an image obtained by vertically reversing the image captured by the camera 12. According to the structure explained above, even if the camera 12 is installed with its vertical direction being reversed, an image recorded by the image recording section 16 is recorded as an image that is always erected without reversing the top-and-bottom direction thereof.

On the other hand, when the camera 12 does not have the vertical mirroring function, as shown in FIG. 4C, the image correcting section 17 of the control section 19 receives the acceleration signal Sz2 from the acceleration sensor 14, vertically reverses the output order of the image signal Sv from the camera 12 to provide the image signal Svm, and outputs this signal to the image recording section 16. In this case, since the top-and-bottom direction of the image recorded by the image recording section 16 is corrected into an upright direction, and hence the top-and-bottom direction of the recorded image is not reversed.

Incidentally, in the FIG. 4C correction method of vertically reversing the order of each image signal Sv to effect correction by using the image correcting section 17 of the control section 19, the following correction method can be also executed. That is, the image correcting section 17 uses gravitational acceleration components (direct-current components Sx, Sy, and Sz in the three directions, i.e., X, Y, and Z) obtained from the three-dimensional acceleration sensor 14 to detect a horizontal inclination of an image captured by the camera 12 based on the vertical acceleration signal Sz and the horizontal acceleration signals Sx, Sy, and others from the acceleration sensor 14, executes image processing of correcting the horizontal inclination, and then outputs to the image recording section 16 the image signal Svm after correction. According to this correction method, the horizontal inclination can be corrected in addition to the top-and-bottom direction of a recorded image.

It is to be noted that this correction of the top-and-bottom direction may be automatically performed when a power supply of the drive recorder 50 is turned on, or it may be automatically performed when installing the camera 12 and this setting may be maintained. Further, a person may arbitrarily push, e.g., a switch to perform this correction. When correction is carried out while the image recording section 16 is recording the image signals Sv and Svm, the top-and-bottom direction of a recorded image may be reversed during reproduction, resulting in a hard-to-see image. Therefore, it is preferable to effect the correcting operation when the recording operation is not carried out.

As understood from the above, according to the drive recorder 50 of the present invention, even if the camera 12 is installed with its vertical direction being reversed (inverted), the image correcting section 17 of the control section 19 can automatically correct the top-and-bottom direction of a captured image based on the vertical acceleration signal Sz from the acceleration sensor 14 whose relative posture with respect to the camera 12 is fixed, thereby recording this image in the image recording section 16.

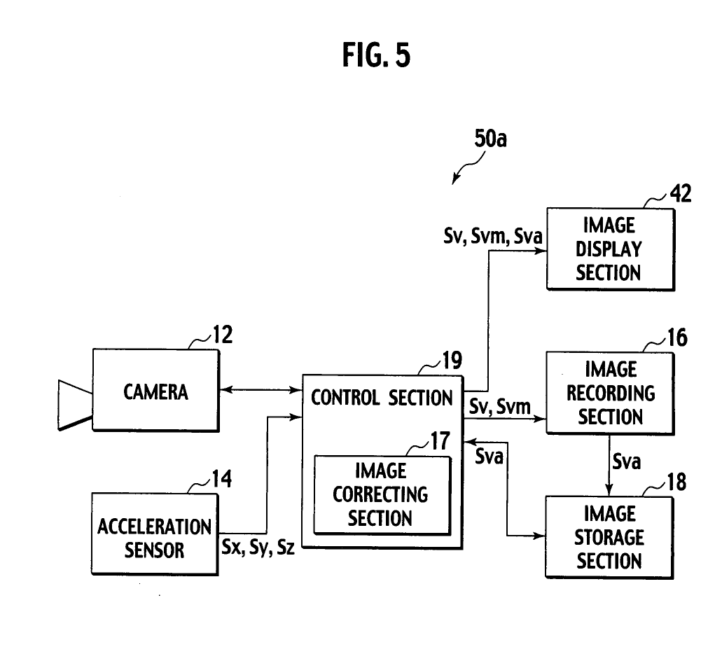

Besides the configuration of the drive recorder 50, the drive recorder according to the present invention may be a drive recorder 50a having an image display section 42 as depicted in a block diagram of FIG. 5. When the image display section 42 is provided, the drive recorder 50a can display an image captured by the camera 12, and can also reproduce and display recorded images before and after occurrence of an accident stored in the image storage section 18 without using, e.g., a personal computer. Further, since a shooting range of vehicle local circumstances shot by the camera 12 can be adjusted while watching captured images in the image display section 42, thus further facilitating installation of the camera 12. It is to be noted that a top-and-bottom direction of an image displayed in the image display section 42 is likewise automatically corrected based on the vertical acceleration signal Sz from the acceleration sensor 14, and hence an image whose top-and-bottom direction is reversed is not displayed irrespective of a vertical direction of the camera 12.

As the image display section 42, a cathode-ray tube may be used. However, using a liquid crystal panel or the like that can be further reduced in size is preferable. Furthermore, the image display section 42 may be provided in the drive recorder 50a, but image signals Sv, Svm, and Sva can be output to and displayed in a display section of an in-vehicle DVD or car navigation system through radio or a cable.

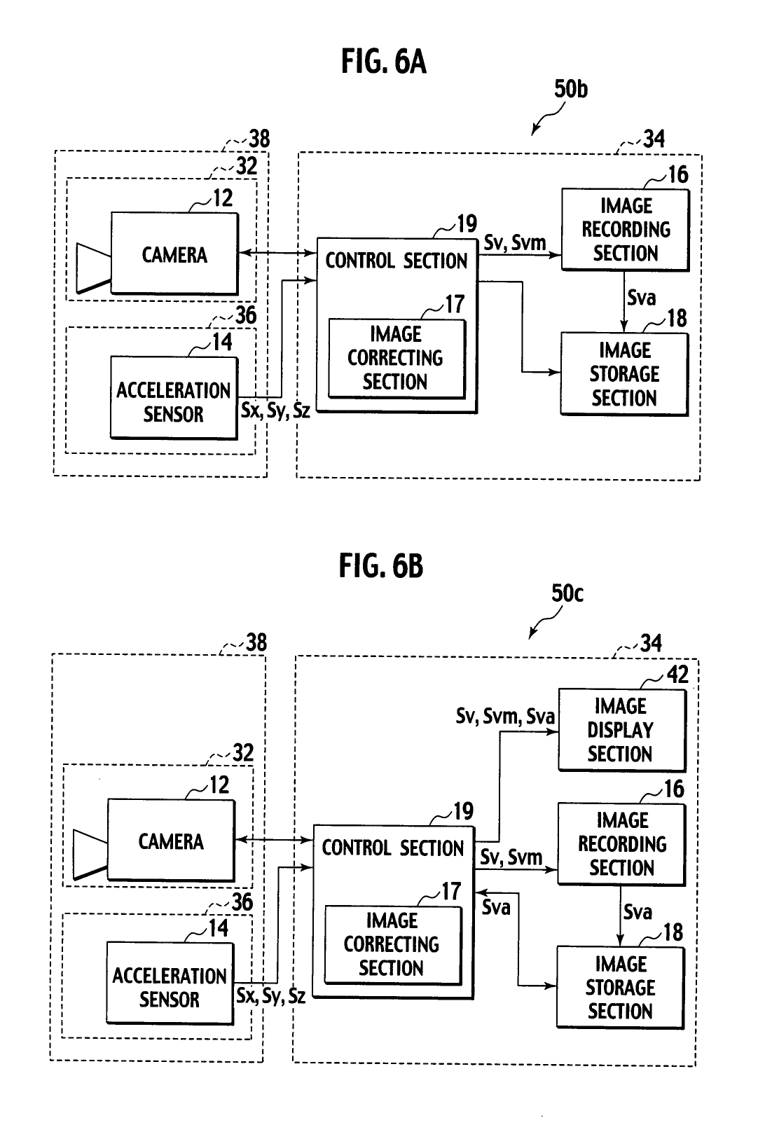

Moreover, in the drive recorder 50 or 50a, the camera 12 and other structures may be integrally provided. Besides, as depicted as drive recorder systems 50b and 50c in FIGS. 6A and 6B, an image capturing section 38 and a main body 34 having the image recording section 16 and other structures may be separately installed at different positions. In this case, a camera section 32 formed of at least the camera 12 and an acceleration detecting section 36 made up of the acceleration sensor 14 are provided in the image capturing section 38, and a relative posture of the acceleration detecting section 36 and the camera section 32 is fixed. As a result, the image correcting section 17 of the control section 19 judges a vertical direction of the camera 12 in the camera section 32 based on the vertical acceleration signal Sz from the acceleration sensor 14 of the acceleration detecting section 36, thereby automatically correcting a top-and-bottom direction of a captured image output from the camera section 32. Therefore, top-and-bottom directions of a recorded image in the image recording section 16 and a displayed image in the image display section 42 depicted in FIG. 6B are not reversed.

It is to be noted that, in case of the drive recorder system 50c having the image display section 42, the image displays section 42 can be disposed integrally with the image capturing section 38 or the main body 34. Besides, a display section of an in-vehicle DVD or car navigation system as an additional body can be utilized. Further, the control section 19 can be disposed on the image capturing section 38 side.

Signals can be transmitted between the image capturing section 38 and the main body 34 in the drive recorder system 50b or 50c based on a wire mode, e.g., a cable. Besides, the image capturing section 38 and the main body 34 can have a transmitting/receiving function to perform signal transmission wirelessly. Further, when signals are transmitted between the image capturing section 38 and the main body 34 wirelessly, the main body 34 does not necessarily have to be installed in a vehicle. The main body 34 can be installed at, e.g., a different position outside the vehicle to remotely control the image capturing section 38 side.

As understood from the above, according to the image correction method for the drive recorder, the drive recorder 50 or 50a, and the drive recorder system 50b or 50c of to the present invention, even if a vertical direction of the camera 12 is reversed, the image correcting section 17 of the control section 19 automatically corrects a top-and-bottom direction of a captured image based on the vertical acceleration signal Sz from the acceleration sensor 14 whose relative posture with respect to the camera 12 is fixed. Therefore, the top-and-bottom direction of an image recorded in the image recording section 16 and that of an image displayed in the image display section 42 are not reversed. Accordingly, the camera 12 of the drive recorder 50 or 50a and the drive recorder system 50b or 50c can be readily installed without being concerned about the vertical direction.

Moreover, since the acceleration sensor 14 of the drive recorder 50 or 50a and the drive recorder system 50b or 50c is used as means for judging a vertical direction of the camera 12, new components are not required, and a component cost is not increased.

Additionally, in the method of correcting the image signal Sv by the image correcting section 17 of the control section 19, image processing of correcting a horizontal inclination of a captured image can be executed based on the vertical acceleration signal Sz, the horizontal acceleration signals Sx and Sy, and others of the three-dimensional acceleration sensor 14, thereby correcting a top-and-bottom direction and a horizontal inclination of a recorded image.

It is to be noted that the example of using the three-dimensional acceleration sensor as the acceleration sensor 14 has been explained in this embodiment. However, the present invention is not restricted to the three-dimensional acceleration sensor, and a uniaxial acceleration sensor or an electrostatic capacity type acceleration sensor can be used as long as at least a vertical acceleration can be sensed.

Additionally, the description has been given as to the example where the acceleration sensor 14 and the camera 12 are installed with a relative posture being fixed in such a manner that a vertical direction of the acceleration sensor 14 becomes parallel with a top-and-bottom direction of the camera 12. However, the vertical direction of the acceleration sensor 14 does not have to be parallel with the top-and-bottom direction of the camera 12 if the relative posture of the acceleration sensor 14 and the camera is fixed to avoid a change and the acceleration sensor 14 can sense at least a vertical acceleration.

Further, in this embodiment, the example where the drive recorder 50 or 50a and the drive recorder 50b or 50c are installed in the vehicle is used. This vehicle can be applied to a movable body using wheels, e.g., an automobile, a two-wheeled vehicle, or a railroad vehicle as well as other mobile bodies, e.g., a personal water craft. Furthermore, the present invention can be modified and carried out without departing from the scope of the invention.

It should be understood that many modifications and adaptations of the invention will become apparent to those skilled in the art and it is intended to encompass such obvious modifications and changes in the scope of the claims appended hereto.

What is claimed is:

1. A recorded image correction method for a drive recorder, comprising:
generating an acceleration signal from a sensor that detects an acceleration; and
correcting a top-and-bottom direction or an inclination of a captured image that is output from a camera and recorded in a drive recorder based on the acceleration signal.

2. A drive recorder comprising:
a camera;
an image recording section that records an image captured by the camera;
a sensor that is installed with its relative posture with respect to the camera being fixed, detects an acceleration, and outputs an acceleration signal; and
an image correcting section that corrects a top-and-bottom direction or an inclination of an image that is recorded in the image recording section based on the acceleration signal.

3. The drive recorder according to claim 2, further comprising an image display section that displays the image output from the camera or the image recorded in the image recording section.

4. A drive recorder system comprising:
a camera;
an image recording section that is different from the camera, receives an image captured by the camera with or without a wire, and records the image;
a sensor that is installed with its relative posture with respect to the camera being fixed, detects an acceleration, and outputs an acceleration signal; and
an image correcting section that corrects a top-and-bottom direction or an inclination of an image that is recorded in the image recording section based on the acceleration signal.

5. The drive recorder system according to claim 4, further comprising an image display section that displays the image output from the camera or the image recorded in the image recording section.
